(19) United States
(12) Patent Application Publication
(10) Pub. No.: US 2021/0264448 A1
(43) Pub. Date: Aug. 26, 2021

(54) PRIVACY PRESERVING AI DERIVED SIMULATED WORLD

(71) Applicant: Visa International Service Association, San Francisco, CA (US)

(72) Inventors: Theodore D. Harris, San Francisco, CA (US); Craig O'Connell, San Mateo, CA (US); Tatiana Korolevskaya, Mountain View, CA (US); Yue Li, San Mateo, CA (US)

(21) Appl. No.: 17/261,676

(22) PCT Filed: Jul. 24, 2019
(86) PCT No.: PCT/US2019/043258

§ 371 Date: Jan. 20, 2021

Related U.S. Application Data
(60) Provisional application No. 62/702,794, filed on Jul. 24, 2018.

(51) Int. Cl. G06Q 30/02; G06N 3/00; G06N 20/00

(52) U.S. Cl. CPC G06Q 30/0201; G06N 20/00; G06N 3/006

(57) ABSTRACT

A method includes a) receiving, by a computer, network data comprising a plurality of transactions conducted by a plurality of actual users and a plurality of actual resource providers. The computer can b) generate a plurality of simulated users. Each simulated user based upon a set of the plurality of actual users. The computer can then c) generate a plurality of simulated resource providers. Each simulated resource provider based upon at least one actual resource provider. The computer can d) execute a simulation using the plurality of simulated users and the plurality of simulated resource providers, and in response to step d) can e) determine a plurality of simulated transactions conducted by the plurality of simulated users and the plurality of simulated resource providers.

### CROSS-REFERENCES TO RELATED APPLICATIONS

This application claims the benefit of U.S. Provisional Application No. 62/702,794, filed Jul. 24, 2018, which is herein incorporated by reference in its entirety for all purposes.

### BACKGROUND

Simulations are created to predict variables and behaviors for a variety of processes and systems. However, in some cases the simulations may not be accurate enough to identify underlying variables. Additionally, current simulations are not privacy preserving and do not protect a user's data that is used to create the model. For example, a simulation may be performed using data collected from users. However, results obtained from the simulation can be directly linked to the users from which the data originates. New improved ways to protect data that is used in machine learning systems and methods are needed.

Embodiments of the disclosure address these and other problems individually and collectively.

### SUMMARY

One embodiment of the disclosure is related to a method comprising: a) receiving, by a computer, network data comprising a plurality of transactions conducted by a plurality of actual users and a plurality of actual resource providers; b) generating, by the computer, a plurality of simulated users, each simulated user based upon a set of the plurality of actual users; c) generating, by the computer, a plurality of simulated resource providers, each simulated resource provider based upon at least one actual resource provider; d) executing, by the computer, a simulation using the plurality of simulated users and simulated resource providers; and e) determining, in response to step d), a plurality of simulated transactions conducted by the simulated users and simulated resource providers.

Another embodiment of the disclosure is directed to a computer comprising: a processor; and a computer-readable medium coupled to the processor, the computer-readable medium comprising code executable by the processor for implementing a method comprising: a) receiving network data comprising a plurality of transactions conducted by a plurality of actual users and a plurality of actual resource providers; b) generating a plurality of simulated users, each simulated user based upon a set of the plurality of actual users; c) generating a plurality of simulated resource providers, each simulated resource provider based upon at least one actual resource provider; d) executing a simulation using the plurality of simulated users and simulated resource providers; and e) determining, in response to step d), a plurality of simulated transactions conducted by the simulated users and simulated resource providers.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a simulation computer according to embodiments.

FIG. 3 shows a flowchart of performing a simulation according to embodiments.

FIG. 4 shows a flowchart of a model tuning method according to embodiments.

### DETAILED DESCRIPTION

Prior to discussing embodiments of the disclosure, some terms can be described in further detail.

An “artificial intelligence model” or “AI model” can include a model that may be used to predict outcomes in order achieve a pre-defined goal. The AI model may be developed using a learning algorithm, in which training data is classified based on known or inferred patterns. An AI model may also be referred to as a “machine learning model” or “predictive model.”

“Machine learning” can include an artificial intelligence process in which software applications may be trained to make accurate predictions through learning. The predictions can be generated by applying input data to a predictive model formed from performing statistical analysis on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

In some embodiments, a model may be a statistical model, which can be used to predict unknown information from known information. For example, a learning module may be a set of instructions for generating a regression line from training data (supervised learning) or a set of instructions for grouping data into clusters of different classifications of data based on similarity, connectivity, and/or distance between data points (unsupervised learning). The regression line or data clusters can then be used as a model for predicting unknown information from known information. Once a model has been built from the learning module, the model may be used to generate a predicted output from a new request. The new request may be a request for a prediction associated with presented data. For example, new request may be a request for classifying an image or for a recommendation for a user.

A “topological graph” can include a representation of a graph in a plane of distinct vertices connected by edges. The distinct vertices in a topological graph may include as “nodes.” Each node may represent specific information for an event or may represent specific information for a profile of an entity or object. The nodes may be related to one another by a set of edges, E. An “edge” may be described as an unordered pair composed of two nodes as a subset of the graph G=(V, E), where is G is a graph comprising a set V of vertices (nodes) connected by a set of edges E. For example, a topological graph may represent a transaction network in which a node representing a transaction may be connected by edges to one or more nodes that are related to the transaction, such as nodes representing information of a device, a user, a transaction type, etc. An edge may be associated with a numerical value, referred to as a “weight”, that may be assigned to the pairwise connection between the two nodes. The edge weight may be identified as a strength of connectivity between two nodes and/or may be related to a cost or distance, as it often represents a quantity that is required to move from one node to the next.

A “subgraph” or “sub-graph” can include a graph formed from a subset of elements of a larger graph. The elements may include vertices and connecting edges, and the subset may be a set of nodes and edges selected amongst the entire set of nodes and edges for the larger graph. For example, a plurality of subgraph can be formed by randomly sampling graph data, wherein each of the random samples can be a subgraph. Each subgraph can overlap another subgraph formed from the same larger graph.

A “community” can include a group of nodes in a graph that are densely connected within the group. A community may be a subgraph or a portion/derivative thereof and a subgraph may or may not be a community and/or comprise one or more communities. A community may be identified from a graph using a graph learning algorithm, such as a graph learning algorithm for mapping protein complexes. Communities identified using historical data can be used to classify new data for making predictions. For example, identifying communities can be used as part of a machine learning process, in which predictions about information elements can be made based on their relation to one another.

A “node” can include a discrete data point representing specified information. Nodes may be connected to one another in a topological graph by edges, which may be assigned a value known as an edge weight in order to describe the connection strength between the two nodes. For example, a first node may be a data point representing a first device in a network, and the first node may be connected in a graph to a second node representing a second device in the network. The connection strength may be defined by an edge weight corresponding to how quickly and easily information may be transmitted between the two nodes. An edge weight may also be used to express a cost or a distance required to move from one state or node to the next. For example, a first node may be a data point representing a first position of a machine, and the first node may be connected in a graph to a second node for a second position of the machine. The edge weight may be the energy required to move from the first position to the second position.

An “epoch” can be a period of time. For example, an epoch can be a period of time of an iteration in training a machine learning model. During training of learners in a learning algorithm, each epoch may pass after a defined set of steps have been completed. In an iterative algorithm, an epoch may include an iteration or multiple iterations of updating a model. An epoch may sometimes be referred to as a “cycle.” In some embodiments, during a simulation, an epoch may represent a period of time (e.g., hour, day, etc.).

“Network data” can include data related to a group and/or system of interconnected people and/or things. In some embodiments, the network data can comprise a plurality of transactions conducted by a plurality of actual consumers and a plurality of actual resource providers.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “user” may include an individual. In some embodiments, a user may be associated with one or more personal accounts and/or mobile devices. The user may also be referred to as a cardholder, account holder, or consumer in some embodiments. In some embodiments, a user may be an actual user.

A “user identifier” can include any piece of data that can identify a user. A user identifier can comprise any suitable alphanumeric string of characters. In some embodiments, the user identifier may be derived from user identifying information. In some embodiments, a user identifier can include an account identifier associated with the user.

An “agent” can include a discrete entity with its own goals and behaviors. In some embodiments, an agent may include a representation of a virtual entity. Agent-based models can comprise dynamically interacting rule-based agents. An agent may be of a certain type. For example, an agent can be a consumer agent, a resource provider agent, a fraudster agent, etc. An agent can comprise data which describes the type of agent. For example, transaction history data corresponding to an actual user (i.e., actual consumer) can be used to determine propensity data for the consumer agent.

A “consumer agent” can be an agent representing a consumer. A consumer agent can be an agent in a simulation. In some embodiments, a consumer agent can be an actual consumer agent. An actual consumer agent may be created based on an actual consumer. In other embodiments, a consumer agent can be a simulant consumer agent. A simulant consumer agent can be created based on a set of consumer agents. In contrast to an actual consumer agent, a simulant consumer agent may not be specifically associated with a single actual consumer.

A “simulation” can include an imitation of a situation and/or process. A simulation can be a computer simulation. In some embodiments, a model may represent a system itself, while a simulation may represent the model's operation over time. A simulation can include any suitable simulation. For example, a simulation can include a continuous simulation, a discrete event simulation, a stochastic simulation, a deterministic simulation, etc.

A “resource provider” may be an entity that can provide a resource such as goods, services, information, and/or access. Examples of a resource provider includes merchants, access devices, secure data access points, etc. A merchant may typically be an entity that engages in transactions and can sell goods or services, or provide access to goods or services. In some embodiments, a resource provider may be an actual resource provider.

A “behavior tree” can include a mathematical model of plan execution. A behavior tree can describe switchings between a finite set of tasks in a modular fashion. In some embodiments, a behavior tree can be graphically represented as a directed tree in which the nodes can be classified as root nodes, control flow nodes, or execution nodes (i.e., tasks). For each pair of connected nodes the outgoing node can be called a parent node and the incoming node can be called child node. The root node may not have any parent nodes and, in some embodiments, may have one child node. The control flow nodes can have one parent node and at least one child node. The execution nodes can have one parent node and, in some embodiments, no child nodes.

The execution of a behavior tree may start from the root node which can send ticks with a certain frequency to its child node(s). A tick can include an enabling signal that allows the execution of a child node. When the execution of a node in the behavior tree is allowed, it can return, to the parent node, a status of “running” if its execution has not finished yet, “success” if it has achieved its goal, or “failure” otherwise.

A “recommendation” can include a suggestion or proposal as to a course of action. A recommendation can include a recommendation for a consumer to purchase a resource that may increase the consumer's satisfaction. A recommendation can be determined by a recommendation engine (i.e., recommender system), where the recommendation is based on a consumer's transaction history, propensity data, and/or community data. A recommendation can be determined by any suitable recommendation engine (e.g., collaborative filtering recommendation engines, content-based filtering recommendation engines, multi-criteria recommendation engines, risk-aware recommendation engines, mobile recommendation engines, hybrid recommendation engines, etc.).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

### I. Systems

As an illustrative example, a computer (e.g., a simulation computer) can receive network data from a network data database. The network data can comprise a plurality of transactions conducted by a plurality of actual users and a plurality of actual resource providers. The computer can then generate a plurality of simulated users. Each simulated user can be based upon a set of the plurality of actual users. The computer can generate a plurality of simulated resource providers. Each simulated resource provider can be based upon at least one actual resource provider. The computer can then execute a simulation using the plurality of simulated users and simulated resource providers. In response to executing the simulation, the computer can determine a plurality of simulated transactions conducted by the simulated users and simulated resource providers.

A. System Architecture

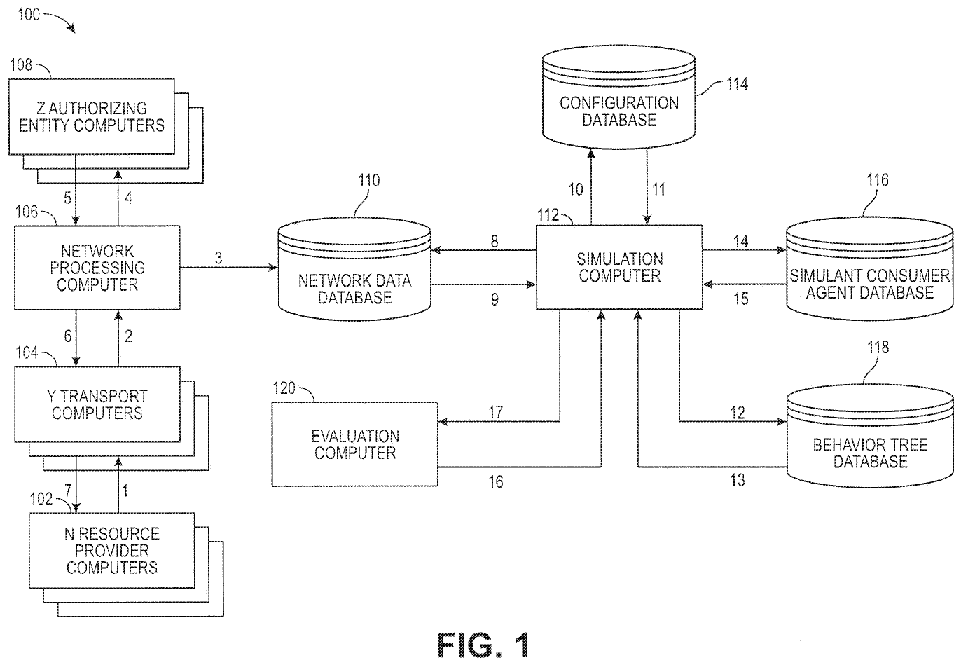

FIG. 1 shows a system 100 comprising a number of components according to embodiments. The system 100 can comprise n resource provider computers 102, y transport computers 104, a network processing computer 106, z authorizing entity computers 108, a network data database 110, a simulation computer 112, a configuration database 114, a simulant consumer agent database 116, a behavior tree database 118, and an evaluation computer 120. The n resource provider computers 102 can be in operative communication with at least one of the y transport computers 104. The y transport computers 104 can be in operative communication with the network processing computer 106. The network processing computer 106 can be in operative communication with the z authorizing entity computers 108 as well as the network data database 110. The network data database 110 can be in operative communication with the simulation computer 112. The simulation computer 112 can be in operative communication with the network data database 110 as well as the configuration database 114, the simulant consumer agent database 116, the behavior tree 118, and the evaluation computer 120.

The devices of system 100 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

For simplicity of illustration, a certain number of components are shown in FIG. 1. It is understood, however, that embodiments of the disclosure may include more than one of each component.

At step 1, n resource provider computers 102 can generate authorization request messages for interactions. The n resource provider computers 102 can each include a computer operated by a resource provider. In some embodiments, a resource provider computer can include a server computer. Each resource provider computer can generate an authorization request message for an interaction, during the interaction between the resource provider and a user. The resource provider computer can then transmit the authorization request message to a transport computer of the y transport computers 104. Each resource provider computer of the n resource provider computers 102 can transmit authorization request messages to different transport computers of the y transport computers 104.

In some embodiments, the n resource provider computers 102 can receive the authorization request messages from access devices associated with the n resource provider computers 102, respectively. An access device can include any suitable device for providing access to an external computer system to a user, for example. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like.

At step 2, after receiving the authorization request message from one of the n resource provider computers 102, the y transport computers 104 can forward the authorization request message to a network processing computer 106. The y transport computers 104 can include computers and/or server computers operated by acquirers, for example.

At step 3, after receiving the authorization request message from a transport computer of the y transport computers 104, the network processing computer 106 can store the authorization request message and/or data associated therewith into a network data database 110. For example, the network processing computer 106 can store transaction data for a transaction into the network data database 110. The transaction data can include any suitable data elements relating to the transaction between a user and a resource provider of the originating resource provider computer (e.g., date, time, amount, resource provider type, resource provider identifier, consumer identifier, SKU (stock keeping unit) codes, location, etc.). The network data database 110 can include any suitable database. The network data database 110 may be a conventional, fault tolerant, relational, scalable, secure database such as those commercially available from Oracle™ or Sybase™ The network data database 110 can store network data.

The network processing computer 106 can include any suitable server computer. The network processing computer 106 may include data processing subsystems, networks, and operations used to support and deliver authorization services, exception file services, transaction scoring services, and clearing and settlement services. An exemplary network processing computer 106 may include VisaNet™. Processing networks such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

At step 4, after storing the relevant data in the network data database 110, the network processing computer 106 can forward the authorization request message to one of z authorizing entity computers 108. The z authorizing entity computers 108 can include any suitable computers. For example, an authorizing entity computer can be configured to determine whether or not to authorize an interaction based on the authorization request message. Examples of authorizing entities can include issuers, governmental agencies, document repositories, access administrators, etc. After receiving the authorization request message, the authorizing entity computer can determine whether or not to authorize the interaction.

At step 5, after determining whether or not to authorize the interaction, the authorizing entity computer of the z authorizing entity computers 108 can generate and transmit an authorization response message to the network processing computer 106. In some embodiments, the network processing computer 106, upon receiving the authorization response message, can store the authorization response message and/or data associated therewith into the network data database 110.

At step 6, the network processing computer 106 can forward the authorization response message to the appropriate transport computer of the y transport computers 104. For example, the network processing computer 106 can determine which transport computer of they transport computers 104 to send the authorization response message to, by evaluating a routing table and/or a data element in the authorization response message indicating the appropriate transport computer.

At step 7, after receiving the authorization response message from the network processing computer 106, the transport computer of the y transport computers 104 can transmit the authorization response message to the appropriate resource provider computer of the n resource provider computers 102, as described herein. In some embodiments, after receiving the authorization response message, the resource provider computer of the n resource provider computers 102 can notify the user of the status of the interaction. For example, the resource provider computer can notify the user via the access device of whether or not the interaction (e.g., a transaction) is authorized.

At any suitable point in time, at step 8, a simulation computer 112 can query the network data database 110 for network data. Any number of interactions may have occurred prior to step 8. The network processing computer 106 can store data related to the plurality of interactions in the network data database 110. For example, the network processing computer 106 can store data related to 10, 500, 2,000, 10,000, etc. interactions into the network data database 110 prior to the simulation computer 112 querying the network data database 110 for network data.

In some embodiments, the simulation computer 112 can query the network data database 110 for network data associated with one or more criteria. For example, one criterion that the simulation computer 112 can include in the query is a time and/or time range. For example, the simulation computer 112 can query for network data that is associated with the past day, past hour, particular date range (e.g., 5/10/2019 to 5/15/2019), etc. As another example, the simulation computer 112 can include a criterion that the retrieved network data include data related to interactions that occurred within a particular geographic area (e.g., North America, California, etc.). Additional example criteria can relate to user demographics, resource provider demographics, spending amount, etc.

At step 9, the network data database 110 can provide the simulation computer 112 with the queried network data. The simulation computer 112 can receive the network data comprising a plurality of transaction data for a plurality of transactions (e.g., 5, 28, 500, 10,000 transactions, etc.). Each transaction data can comprise a plurality of data elements (e.g., zip code, merchant identifier, user identifier, amount, IP address, date, time, etc.) with data values (e.g., 94016, merchant_1234, user_1234, $19.99, 111.111.11.111, 01/01/2015, 11:00 AM PT, respectively corresponding to the data elements).

At step 10, after receiving the network data, the simulation computer 112 can query the configuration database 114 for one or more configurations. A configuration can include files used to configure parameters and/or initial settings. A configuration file can be of any suitable file format (e.g., XML, JSON, YAML, INI, etc.). In some embodiments, a configuration file can include details regarding an initial state of a simulation.

At step 11, the configuration database 114 can provide the simulation computer 112 with the queried configuration(s). For example, the simulation computer 112 can query the configuration database 114 for a Bay Area simulation configuration. The Bay Area simulation configuration can include data relating to values which represent the Bay Area (e.g., ZIP codes, addresses, common types of resource providers in the area, income data, spending data, etc.).

In some embodiments, a configuration can include initial settings describing events that may occur at particular times during the simulation. An event can comprise data such as duration data (e.g., event start time, event end time, etc.), scale data (e.g., which agents are related with by the event, etc.), and impact data (e.g., economic impact, fraud impact, etc.). A configuration can include events of, for example, disasters, sales, data breaches, and/or any event that effects the system.

At step 12, the simulation computer 112 can query the behavior tree database 118 for one or more behavior trees. At step 13, the behavior tree database 118 can provide the simulation computer 112 with the queried behavior tree(s). A behavior tree can be a tree of hierarchical nodes that control the flow of decision making of an AI entity (e.g., an agent). At the extents of the tree, the leaves, can be commands that control the AI entity, and forming the branches are various types of utility nodes that control the AI's path through the behavior tree to reach the sequence(s) of commands best suited to the situation. The behavior trees can be of any suitable depth (e.g., any suitable number of nodes of the behavior tree between the root node and the execution nodes). In some embodiments, a node of the behavior tree can call, or otherwise reference, a sub-tree (i.e., sub-behavior tree), which can perform particular functions. In some embodiments, the branches leading to child nodes from a node can be associated with a weight in order to allow the AI to have fallback behavior's should the highest weighted execution node fail. A behavior tree can describe behaviors of an associated agent. For example, a consumer agent can be associated with a behavior tree (e.g., a consumer behavior tree).

At step 14, the simulation computer 112 can query the simulant consumer agent database 116 for a plurality of simulant consumer agents. At step 15, the simulant consumer agent database 116 can provide the plurality of simulant consumer agents to the simulation computer 112. The plurality of simulant consumer agents can include any suitable number of simulant consumer agents (e.g., 5, 50, 110, 300, 5000, etc.). A simulant consumer agent can include an agent which can be generated by the simulation computer 112 to simulate a consumer. Simulant consumer agents are described in further detail herein.

In some embodiments, the simulation computer 112 can perform steps 10, 12, and 14 in any order or concurrently. For example, in embodiments, the simulation computer 112 can query the simulant consumer agent database 116 for the plurality of simulates, then query the behavior tree database 118 for behavior tree(s), and then query the configuration database 114 for configuration(s).

After retrieving the network data, configuration(s), simulant agent(s), and behavior tree(s), the simulation computer 112 can perform a simulation which can simulate interactions (e.g., transactions, etc.) between consumer agents and resource provider agents.

At step 16, the evaluation computer 120 can generate and transmit a simulation request message to the simulation computer 112. The simulation request can include a request for results and/or predictions derived from a simulation. For example, the evaluation computer 120 can request a list of simulated transactions performed by a particular consumer agent, a resource provider agent, a type of resource provider (e.g., food vendors, electronics stores, etc.), a community group of consumer agents, etc.

At step 17, after receiving the simulation request message from the evaluation computer 120, the simulation computer 112 can determine the data relevant to the requested results and/or predictions. For example, the simulation computer 112 can retrieve a list of simulated transactions performed by consumer agents which belong to a “high tech user” community group. The simulation computer 112 can then generate a simulation response message comprising the list of simulated transactions. The simulation computer 112 can transmit the simulation response message to the evaluation computer 120. The evaluation computer 120 can then perform additional processing.

The additional processing performed by the evaluation computer 120 can include recommending a resource to an actual user associated with an actual consumer agent which performed a simulated transaction for a digital representation of the resource. The evaluation computer 120 can also recommend a resource to one or more actual users based on simulated transactions performed by consumer agents of a similar community group. For example, a simulant consumer agent may be associated with a “high tech” community group and may perform 10 simulated transactions during the simulation. The evaluation computer 120 can determine actual consumers that are also associated with the “high tech” community group and may generate one or more recommendations for actual resources for the actual consumers based on the simulated transactions performed by the simulant consumer agent. Additional processing may also include analyzing the simulated transactions for trends in purchasing habits, adjusting parameters of the simulation based on the resulting simulated transactions, etc.

The databases depicted in system 100 (e.g., the network data database 110, the configuration database 114, the simulant consumer agent database 116, and the behavior tree database 118) may be a conventional, fault tolerant, relational, scalable, secure databases such as those commercially available from Oracle™ or Sybase™.

B. Simulation Computer

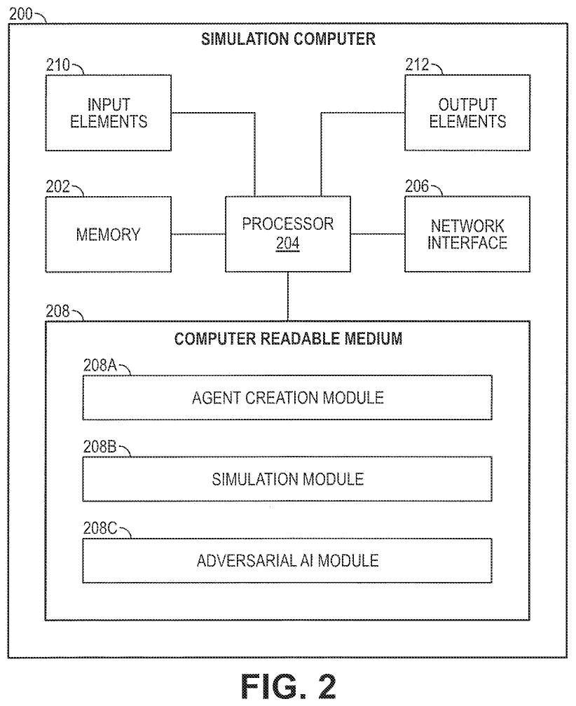

FIG. 2 shows a block diagram of a simulation computer 200 according to embodiments. The exemplary simulation computer 200 may comprise a processor 204. The processor 204 may be coupled to a memory 202, a network interface 206, input elements 210, output elements 212, and a computer readable medium 208. The computer readable medium 208 can comprise an agent creation module 208A, a simulation module 208B, and an adversarial AI module 208C. The simulation computer 200 can be the simulation computer 112 portrayed in FIG. 1.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store cryptographic keys, network data, etc.

The input element 210 may include any suitable device capable of inputting data into the simulation computer 200. Examples of input devices include buttons, touchscreens, touch pads, microphones, biometric scanners etc. The one or more input elements 210 may include any suitable device(s) capable of inputting data into the simulation computer 200. Examples of input elements 210 include buttons, touchscreens, touch pads, microphones, etc.

The output element 212 may comprise any suitable devices that may output data. Examples of output elements 212 may include display screens, speakers, and data transmission devices. The one or more output elements 212 may comprise any suitable device(s) that may output data. Examples of output elements 212 may include display screens, speakers, and data transmission devices. For example, the output elements 212 can include a display screen capable of displaying a response value to a user of the simulation computer 200.

The computer readable medium 208 may comprise code, executable by the processor 204, for performing a method comprising: a) receiving, by a computer, network data comprising a plurality of transactions conducted by a plurality of actual users and a plurality of actual resource providers; b) generating, by the computer, a plurality of simulated users, each simulated user based upon a set of the plurality of actual users; c) generating, by the computer, a plurality of simulated resource providers, each simulated resource provider based upon at least one actual resource provider; d) executing, by the computer, a simulation using the plurality of simulated users and simulated resource providers; and e) determining, in response to step d), a plurality of simulated transactions conducted by the simulated users and simulated resource providers.

The agent creation module 208A may comprise code or software, executable by the processor 204, for creating agents. The agent creation module 208A, in conjunction with the processor 204, can create agents of any suitable type. For example, the agent creation module 208A, in conjunction with the processor 204, can create consumer agents (e.g., simulant consumer agents and/or actual consumer agents), resource provider agents (e.g., simulant resource provider agents and/or actual resource provider agents), and/or fraudster agents. The agent creation module 208A, in conjunction with the processor 204, can create agents using at least network data and external data. The network data can comprise transaction data. The external data can include economic data, household data, event data, or any other suitable type of data that is not included in the network data.

In some embodiments, the agent creation module 208A, in conjunction with the processor 204, can create agents based on actual consumers and actual resource providers. The agent creation module 208A, in conjunction with the processor 204, can receive network data comprising transactions performed by a plurality of actual consumers and a plurality of actual resource providers. The agent creation module 208A, in conjunction with the processor 204, can create an actual consumer agent based on transactions performed by an associated actual consumer. The actual consumer agent can be a data item which can represent the actual consumer. The actual consumer agent can include data included in the network data (e.g., transactions, etc.) and/or data derived therefrom (e.g., community groups, etc.).

For example, the agent creation module 208A, in conjunction with the processor 204, can determine a community group to which the actual consumer belongs. The agent creation module 208A, in conjunction with the processor 204, can determine community group to which the actual consumer belongs in any suitable manner. For example, the agent creation module 208A, in conjunction with the processor 204, can implement an unsupervised learner capable of clustering nodes in the network data representing the actual consumers into one or more community groups.

For example, the simulation computer 200 can group data items, for example nodes of a graph (which may represent consumer agents), into groups (e.g., clusters) based on how similar the nodes are to one another. In some embodiments, the simulation computer 200 can perform an unsupervised learning algorithm which can include a graph learning process that can group nodes into dense clusters based on distance. For example, the learning process can include the following: 1) create a sorted list of edges using an edges' connectivity and overall count as a weight; 2) for each edge, generate a descending sorted collection of neighboring edges using the above defined weight as the sort by; 3) for each neighboring edge, generate the distance between the neighbor and the target edge; 4) if a distance is greater than a cut off value, then add the neighboring edge to a community; and 5) repeat until all edges are associated with a community.

Examples of suitable learning algorithms for identifying communities may include: Fastgreedy, Spinglass, Walktrap, Edge Betweenness, Infomap, Label Propagation, Optimal Modularity, and Multilevel. Furthermore, the graph learning algorithm can be an algorithm that identifies communities that overlap one another (i.e., shared nodes). For example, a graph learning algorithm typically used for identifying protein complexes based on overlapping clusters can also be used to classify nodes in any interaction network (e.g., grouping nodes of a transaction network). The graph learning algorithm may comprise computing a weight of each node in the topological graph based on the computed weights of each of the edges, and generating a queue comprising the nodes in decreasing order by weight. A seed node may be selected from the top of the queue to generate a community. Calculated interaction probabilities between nodes can then be used to add nodes to the community in an iterative manner. The added nodes can then be removed from the queue, and the node left at the top of the queue can be used as a seed for the next community. This process can then be repeated, until the queue has been emptied, to generate a plurality of communities. Further detail regarding community group determination can be found in U.S. Pub. No. US 2019/0005407 filed on Jun. 30, 2017, which is herein incorporated by reference in its entirety for all purposes.

The agent creation module 208A, in conjunction with the processor 204, can further utilize external data (e.g., economic data, household data, event data, and/or any other suitable type of data that is not included in the network data) to generate the actual consumer agents and/or the actual resource provider agents. For example, the agent creation module 208A, in conjunction with the processor 204, can determine an income for the actual consumer agent from economic data and/or household data. In other embodiments, the agent creation module 208A, in conjunction with the processor 204, can calculate an estimate of income for the actual consumer agent. For example, the agent creation module 208A, in conjunction with the processor 204, can estimate the income based on the transaction history associated with the actual consumer as well as a typical spending rate of the actual consumer's geographic area (e.g., included in the economic data). The agent creation module 208A, in conjunction with the processor 204, can further determine any other suitable data for the actual consumer agent and/or the actual resource provider agent using analytical data techniques, as known to one of skill in the art.

In other embodiments, the agent creation module 208A, in conjunction with the processor 204, can be capable of creating simulant consumer agents and/or simulant resource provider agents. A simulant consumer agent can represent a consumer in the simulation, but may not be a representation of an actual consumer. For example, a simulant consumer agent can be determined by randomly selecting values for the data of the simulant consumer agent, where the randomly selected values are of a suitable range for the associated data.

The agent creation module 208A, in conjunction with the processor 204, can determine a simulant consumer agent based on data associated with a plurality of actual consumers. As an illustrative example, the agents can be modeled using deep learning. In some embodiments, the simulation computer can data for each agent using external data.

In some embodiments, to build the model, the simulation computer can first determine the resources of the resource baskets. In some embodiments, the resource baskets can be determined by a resource provider code. The simulation computer can determine the three variables of the resource baskets (e.g., duration data, cost data, and reward data). The duration can be determined to be the mean for a truncated exponential decay function based on an average time between consumer visits. The reward can be determined to be a unit of measure derived from the average consumption of substitute items between visits. The cost can be determined based on a dollar amount, a time of day, and/or a payment type.

The simulation computer can then determine the variables of the consumer agent (e.g., community, propensity, and constraints). The community can be determined using a deep, or graph based, unsupervised learner capable of clustering people in multiple communities. This can be similar to building a recommendation engine by a resource provider code, MCC. The propensity can be determined for each MCC and can be the average amount of reward received. The constraints, such as a budget, can be determined to be an estimated weekly income and free time.

The simulation computer can determine the variables of the resource provider agent (e.g., community data, strategy data, and environment data). The community data can be determined from the network data, e.g., derived from which consumers interact with which resource providers. The strategy data can be determined based on, for example, a price and volume variation through seasons, fraud mitigation techniques, etc. The environment data can be determined using the crime rate at zip code or location, economic conditions, etc. The environment data can also be determined using other environment data in both the network data and the external data.

The simulation computer can create the agents using any suitable data. The data can include network data and external data (e.g., household census data, economic census data, event data, etc.). In some embodiments, the simulation computer can use the network data to determine consumer agent community groups, resource provider agent community groups, and resources for a resource basket provided by the resource provider agent. As examples, household census data can be used to determine wealth of the consumer agent as well as to define the environment for the resource provider agent. Economic census data and the event data can be used to determine resource provider agent strategy.

As an illustrative example, the agent creation module 208A, in conjunction with the processor 204, can create an actual consumer agent which may represent a first user associated with a first user identifier (e.g., USER_123) and a plurality of transactions. The agent creation module 208A, in conjunction with the processor 204, can determine a community group to which the first user belongs based on the plurality of transactions (i.e., the transaction history). The first user can be included in a “high tech user” community group based on their purchases of new phones, computers, televisions, etc. The agent creation module 208A, in conjunction with the processor 204, can then determine constraint data which constrains the actions of the actual consumer agent (e.g., income, working hours (i.e., schedule), geographic location, etc.). For example, the first user may have an income of “$50,000,” working hours of “8:00 AM-5:00 PM,” and a geographic location of “Emeryville Calif.” The agent creation module 208A, in conjunction with the processor 204, can further determine propensity data for the first user. For example, the agent creation module 208A, in conjunction with the processor 204, can determine a recommendation for resources to purchase for the first user based on the community group and transaction history. For example, if the first user purchases a new phone every 6 months, then the propensity data can include a satisfaction level that is high if the first user has recently purchased a new phone or a low satisfaction level if the first user has not recently purchased a new phone. The satisfaction level may decay, using any suitable decay function, based on a time scale of 6 months.

The simulation module 208B may comprise code or software, executable by the processor 204, for performing a simulation. The simulation can include an imitation of a situation and/or process. The simulation can include any suitable simulation (e.g., a continuous simulation, a discrete event simulation, a stochastic simulation, a deterministic simulation, etc.). The simulation module 208B, in conjunction with the processor 204, can be capable of implementing a pollinator-plant simulation which may simulate interactions between pollinators (e.g., simulated as consumer agents) and plants (e.g., simulated as resource provider agents). For example, the simulation module 208B, in conjunction with the processor 204, may iterate through a list of consumer agents and may determine whether or not each consumer agent can perform a simulated transaction for a recommendation during the current epoch based on data associated with the consumer agent (e.g., constraint data) and on data associated with the resource provider agent (e.g., if a consumer capacity value has not been exceed during the current epoch). The simulation module 208B, in conjunction with the processor 204, can determine whether or not a simulated transaction may be performed based on, for example, if a recommendation is non-zero, if a consumer agent is available, if a resource provider is available, etc. The simulation module 208B, in conjunction with the processor 204, can perform the simulation as described in further detail herein.

The adversarial AI module 208C may comprise code or software, executable by the processor 204, for implementing an adversarial AI. The adversarial AI module 208C, in conjunction with the processor 204, can be configured to determine whether an input consumer agent is an actual consumer agent or a simulant consumer agent. The adversarial AI module 208C, in conjunction with the processor 204, can determine the type of consumer agent using a support vector machine (SVM). A support vector machine can include a supervised learning model with associated learning algorithms that analyze data used for classification and regression analysis. Given a set of training examples, each marked as belonging to one or the other of two categories (e.g., simulant consumer agent or actual consumer agent), an SVM training algorithm can build a model that assigns new examples to one category or the other, making it a non-probabilistic binary linear classifier. An SVM model can be a representation of the examples as points in space, mapped so that the examples of the separate categories are divided by a clear gap that is as wide as possible and divided by a hyperplane. New examples can then be mapped into that same space and predicted to belong to a category based on which side of the gap they fall. In some embodiments, the adversarial AI module 208C, in conjunction with the processor 204, can perform linear classification or non-linear classification.

The network interface 206 may include an interface that can allow the simulation computer 200 to communicate with external computers. The network interface 206 may enable the simulation computer 200 to communicate data to and from another device (e.g., an evaluation computer, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### II. Simulation Overview

As data privacy concerns grow, but demands to use data to help consumers, resource providers, and issuers persist, a method is needed to enable network data to be used in intelligent decision making. By creating a simulated world, comprising simulant consumer agents and actual consumer agents, based on overlapping communities and tuned through adversarial AI, real world predictions can be extracted without revealing or identifying data of a particular individual. This simulated environment can be better at identifying underlying motivations at an interest level than traditional modeling methods that use high resolution data on individuals. In some embodiments, consumers and resource providers can be modeled using a pollinator/plant framework to model the social aspect of interactions between the consumers and the resource providers. The interactions between the consumers and the resource providers can be any suitable type of interaction, such as a transaction.

The simulated world can run in epochs. In each epoch, each modeled agent (e.g., agents representing consumers, resource providers, etc.) can be updated. For example, a consumer agent can perform a transaction with a resource provider agent to purchase a resource from a resource basket offered by the resource provider agent. The transaction in this epoch can be used to update the data associated with the consumer, which can then be used in future epochs.

A. Simulations

A simulation can include an imitation of a situation and/or process. For example, a simulation can include a mathematical simulation representing a system and/or process. The simulation can include any suitable simulation (e.g., a continuous simulation, a discrete event simulation, a stochastic simulation, a deterministic simulation, etc.). The simulation computer can be capable of implementing a pollinator-plant simulation which may simulate interactions between pollinators (e.g., simulated as consumer agents) and plants (e.g., simulated as resource provider agents). Data can be decomposed into driving factors for the actual consumers and the actual resource providers. These driving factor can be used to create simulant consumer agents, which can be subjected to experiments, used to project trends, and run what-if scenarios. A simulation that may be performed by the simulation computer is described in further detail in section III.

Further details regarding simulations utilizing bipartite graphs can be found in [Pavlopoulos, Georgios A., et al. “Bipartite graphs in systems biology and medicine: a survey of methods and applications.” Gigascience 7.4 (2018): giy014.], and details regarding a pollinator-plant simulation can be found in [Poppenwimer, Tyler L., “Generalist and Specialist Pollination Syndromes: When are they Favoured? A Theoretical Approach to Predict the Conditions Under which a Generalist or Specialist Pollination Syndrome is Favoured.” (2014). Senior Independent Study Theses. Paper 6166.], which are herein incorporated by reference in their entirety for all purposes.

B. Agents

An agent can include a discrete entity with its own goals and behaviors. Agent-based models can comprise dynamically interacting rule-based agents. The simulation computer can execute a simulation, as described herein, with different types of agents. For example, the simulation may be performed with consumer agents, resource provider agents, fraudster agents, etc.

1. Consumer Agents

A consumer agent can be a simulant consumer agent or an actual consumer agent. The simulant consumer agents can be consumer agents that are generated by the simulation computer. In some embodiments, a simulant consumer agent can represent a plurality of actual consumers in the network data. The actual consumer agents can be consumers in the simulation that have the same, or similar, characteristics to an actual consumer in the network data.

Each consumer agent can comprise any suitable data which represents a consumer. For example, each consumer agent can comprise community data, constraint data, and propensity data. The community data can include data relating to which community groups the consumer agent belongs. The constraint data can include income, hours (e.g., a schedule of the consumer agent), max spend, geographic location, etc. The propensity data can include data related to the consumer agent's inclination to behave in a particular manner. For example, the propensity data can include a satisfaction level (i.e., values indicating the consumer agent's desire to purchase particular resources).

The satisfaction level, included in the propensity data, can indicate how satisfied a consumer agent is with current resources in an inventory of the consumer agent. The inventory can be a data item which comprises each of the resources that the consumer agent is currently in possession of (e.g., associated with). In some embodiments, the satisfaction level can be determined for a particular type of resource. For example, if a user purchases a new phone every 6 months, as indicated in the network data, then the consumer agent's satisfaction for “tech” can be high (i.e., highly satisfied) if the consumer agent has recently purchased a new phone. The consumer agent's satisfaction for “tech” can decay over each subsequent epoch (e.g., decrease proportional to the consumer agent's frequency of purchases of “tech”).

Some of this data (e.g., propensity data, etc.) may not be directly observed. However, when a resource provider agent and consumer agent interact (e.g., transact), these interactions can reveal this hidden data. And when a large enough sample of transactions is collected, an even greater number of hidden data can be determined with great precision. When a consumer agent shops, their interactions can be driven by factors such as their environment, their previous transactions, their satisfaction level, etc.

As an example, a consumer agent can be as follows:

```
consumer_agent_1{
  community_data = {“high tech”},
  constraint_data = {income = $50,000,
    work_start = 8:00 AM,
  work_end = 5:00 PM,
  geographic_location = “Emeryville CA”},
  propensity_data = {tech_satisfaction_level = 5/10,
  food_satisfaction_level = 8/10,
  literature_satisfaction_level = 10/10,
  overall_satsifaction_level = 8/10}
}
```

2. Resource Provider Agents

A resource provider agent can be a simulant resource provider agent or an actual resource provider agent. The simulant resource provider agents can be resource provider agents that are generated by the simulation computer. In some embodiments, a simulant resource provider agent can represent a plurality of actual resource providers in the network data. The actual resource provider agents can be resource providers in the simulation that can have the same, or similar, characteristics to an actual resource provider in the network data.

The resource provider agents can comprise any suitable data which represents a resource provider. For example, each resource provider agent can comprise environment data, strategy data, and community data. The environment data can include economic condition, crime rate, etc. The strategy data can include fraud mitigation, pricing, etc. The community data can include data relating to which community groups the resource provider agent belongs.

Like with consumer agents, new resource provider agents can be generated. In some embodiments, a new resource provider agent may be created during the simulation and may represent a new market. For example, if many consumer agents have low satisfaction levels, then a new resource provider agent may be created which may be associated with resources which can increase the satisfaction levels of the consumer agents. In some embodiments, the resource provider agents can be modeled as plants in the pollinator-plant simulation.

Each resource provider agent can be associated with a resource basket. A resource basket include goods and/or services (i.e., resources) that a resource provider agent can provide to a consumer agent. The resource basket can comprise data such as duration data, reward data, and cost data for each resource. The duration data can include how long the reward lasts. The reward data can include how satisfied the consumer agent is, etc. For example, the reward can be a value representing how much the resource may affect a consumer agent's satisfaction level. A high quality resource may have a higher reward than a low quality resource. The cost data can include the cost of the resources in money, time, etc. The resource basket can be modeled as nectar provided by the plant (e.g., the resource provider agent) in the pollinator-plant simulation.

As an example, a resource provider agent can be as follows:

environment data, strategy data, and community data. The environment data can include economic condition, crime rate, etc. The strategy data can include fraud mitigation, pricing, etc. The community data can include data relating to which community groups the resource provider agent belongs.

```
resource_provider_agent_1{
  community_data = {“electronics”},
  environment_data = {crime rate = 1/100 transactions,
    economic_condition = {estimated_sales = $1,000,000}},
  strategy_data = {resource_price_range = $50.00-$5,000.00,
    fraud_mitigation_rate = 30/100 instances of fraud}
}
```

3. Fraudster Agents

In some embodiments, a fraudster agent may be present in the simulation. A fraudster agent can represent a fraudster. A fraudster agent can be an entity that commits fraud in the simulation. The fraudster agent can comprise any suitable data. For example, the fraudster agent can comprise opportunity data, resource data, and strategy data. The opportunity data can include location, reach, time zone, etc. The opportunity data for the fraudster agent can indicate where the fraudster agent may perform and/or attempt to perform fraudulent transactions. The resources data can include an ability to execute fraud (i.e., resources which may allow the fraudster agent to commit fraudulent activities), etc. The strategy data can include targeting one individual, running scripts, etc. The fraudster agent can also represent crime that can be simulated to predict future response to new models, procedural changes, new technologies (e.g., deep learning empowered crime), and changes in economic conditions. The fraudster agent can be modeled as a parasitic wasp in the pollinator-plant simulation.

As an example, a fraudster agent can be as follows:

```
fraudster_agent_1{
  opportunity_data = {location = “Emeryville CA”,
    reach = 50 mile radius,
    time_zone = GMT-7},
  resource_data = {Two model XXXX server computers},
  strategy_data = {number_of_individuals = 1,
    fraud_type = “automated online scripts”}
}
```

### III. Methods

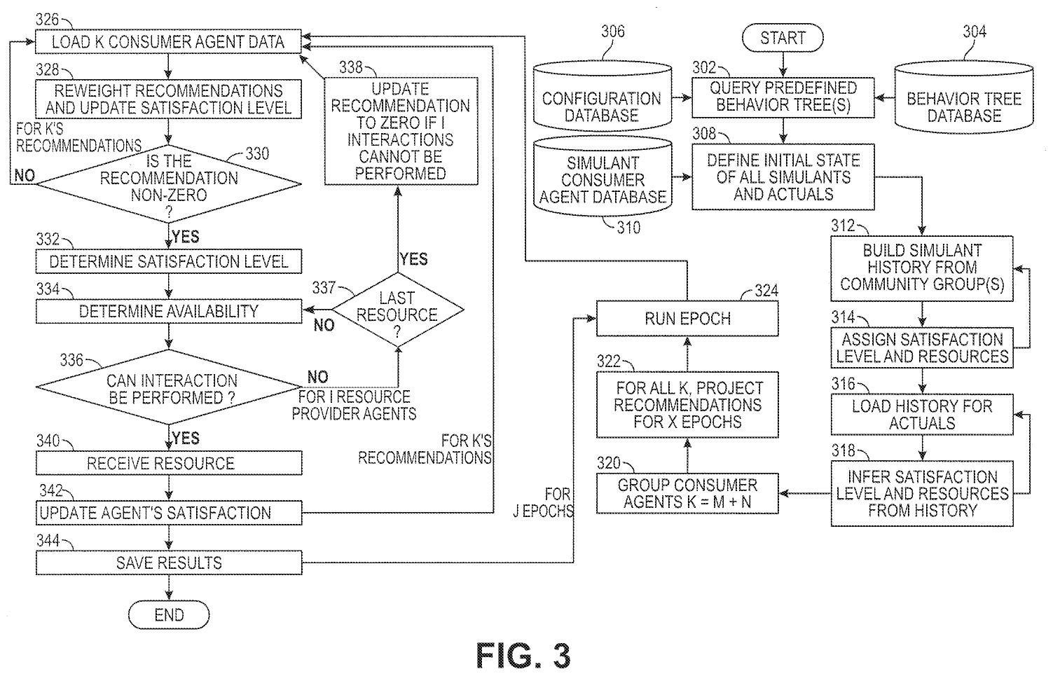

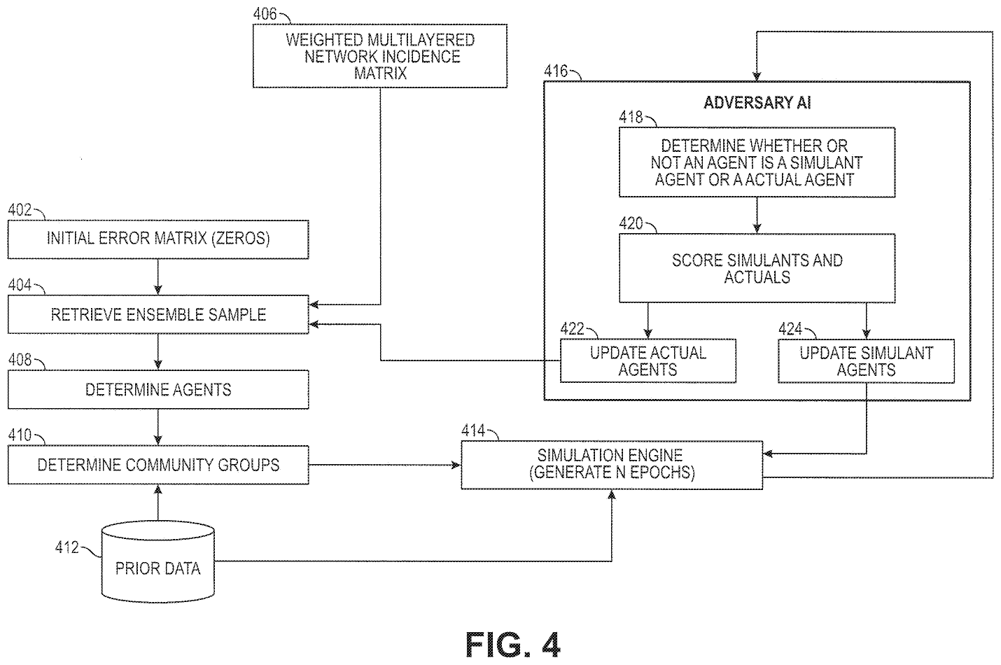

Embodiments can use the systems and apparatuses described herein to at least execute a simulation using consumer agents and resource provider agents. FIGS. 3-4 describe some examples of such methods. In some embodiments, the simulation computer may include the simulation computer 112 or the simulation computer 200 of FIGS. 1 and 2, respectively.

A. Simulation Engine Method

The simulation framework can simulate consumers (e.g., as consumer agents) and resource providers (e.g., as resource provider agents) using a pollinator-plant simulation. The simulation can be a stochastic based simulation where each entity can be simulated in a sequential basis. A sequential method can be used to enable running the simulation in a distributed manner.

A set of recommendations can be determined for each consumer agent in the simulation based on the network data. If the consumer agent's satisfaction level for a particular segment (e.g., technology, food, household goods, etc.) falls below a pre-defined threshold, then the consumer agent can attempt to execute on a recommendation in a recommendation priority list (e.g., perform a transaction). The transaction may or may not be performed based on the consumer agent's and resource provider agent's availability.

The simulation computer can determine the effects of a number of events by including the event in the simulation. In some embodiments, effects of disasters can be simulated. For example, the effects of a hurricane on a location can be determined. Another use case can be to determine exposure from a credit card breach. Yet another use case can be to run what-if scenarios with changes in fraud rules. For example, the simulated world can be evaluated multiple times with different fraud rules. The simulated transactions of each simulation can be compared to determine the effect of the differing fraud rules.

FIG. 3 shows a flowchart of generating a simulated world according to embodiments. The method may be described in the context of a simulated world comprising resource provider agents, consumer agents, etc. However, embodiments of the disclosure are not limited thereto.

At steps 302-304, the simulation computer can query a behavior tree database for predefined behavior tree(s). A behavior tree can include a mathematical model of plan execution, as described herein. The simulation computer can query any suitable number of predefined behavior tree(s). For example, the simulation computer can query the behavior tree database for an actual consumer behavior tree, a simulant consumer behavior tree, a resource provider behavior tree, and/or any other suitable behavior tree(s) (e.g., a fraudster behavior tree). In some embodiments, the simulation computer can retrieve behavior trees which may correspond to previously determined community groups. For example, the simulation computer can retrieve a “high tech” community behavior tree, an “outdoor enthusiast” behavior tree, a “literature” community behavior tree, etc.

At step 306, the simulation computer can also receive one or more configurations. A configuration can include files used to configure parameters and/or initial settings, as described herein. For example, the simulation computer can query a configuration database for a Bay Area simulation configuration. The Bay Area simulation configuration can include data relating to values which represent the Bay Area (e.g., ZIP codes, addresses, common types of resource providers in the area, income data, spending data, etc.).

At steps 308-310, based on the selected configuration, the simulation computer can define the initial state of simulant consumer agents and actual consumer agents. In some embodiments, the simulation computer can retrieve the simulant consumer agents from a simulant consumer agent database. For example, the initial state of the simulant consumer agents and the actual consumer agents can include initial values for community data, constraint data, and propensity data. The community data can include data relating to which community groups the simulant consumer agent or actual consumer agent belongs. The community data can be determined via a clustering process as described herein. For example, community groups can be ranked based on a proximity to the configuration (e.g., the configuration can include a plurality of community groups that may be present during the simulation). For the simulant consumer agents, the community data can include randomly selected community groups that may be within the highest ranking community groups. In some embodiments, for the simulant consumer agents, the community data can include randomly selected community groups and may be of a distribution of community groups representative of the network data. The constraint data can include data which may constrain actions performed by the simulant consumer agent or actual consumer agent. For example, the constraint data can include budget data, income data, working hours data, sleeping hours data, etc. The constraint data may be determined based on external data as described herein. The propensity data can include data related to the simulant consumer agent's or actual consumer agent's inclination to behave in a particular manner. For example, the propensity data can include a satisfaction level (i.e., values indicating a consumer agent's desire to purchase particular resources).

In some embodiments, initial values may be zero or non-zero depending on whether or not the initial values are values from the network data and/or the external data. For example, a simulant consumer agent may not yet be associated with a transaction history. The initial values may be zero values, or null values. The simulant consumer agent's transaction history can be determined at step 312.

At step 312, the simulation computer can build the simulant consumer agent's transaction history data from community group(s). The community group(s) to which a simulant consumer agent belongs can be predetermined and stored in the simulant consumer agent database or can be determined by an unsupervised learner capable of clustering the simulant consumer agents and, in some embodiments, the actual consumer agents into one or more community groups based on the similarities of the simulant consumer agents and, in some embodiments, the actual consumer agents.

The simulation computer can generate random simulated transactions for a transaction history associated with each simulant consumer agent of the plurality of simulant consumer agents. In some embodiments, the random simulated transactions can be based on a set of the plurality of actual consumers (e.g., a community of actual consumers, a groups of actual consumers which the simulant consumer agent represents, etc.).

For example, the simulation computer can assign random simulated transactions to each simulant consumer agent of the plurality of simulant consumer agents. The simulation computer can assign any suitable number (e.g., 5, 10, 100, 250, etc.) of simulated transactions to each simulant consumer agent. For example, the simulation computer can use any suitable random function to determine a random number. Each number can correspond to a simulated transaction that can be associated with the simulant consumer agent. For example, the simulation computer can randomly generate 3 random numbers of 2, 5, and 8. The random numbers of 2, 5, and 8 can correspond to simulated transactions for resources of a car, a laptop, and a television. As an illustrative example, the simulation computer can determine the resources based on a random resource assignment table as shown in Table 1 below.

TABLE 1
Random simulated transaction assignment table

| Random Value | Resource of the transaction |
|---|---|
| 1 | Kitchenware |
| 2 | Car |
| 3 | Couch |
| 4 | Vacuum |
| 5 | Laptop |
| 6 | Smart device |
| 7 | Necklace |
| 8 | Television |

In some embodiments, at steps 312-314, the simulation computer can generate a simulant consumer agent's transaction history based on the community group associated with the simulant consumer agent. The community group can be, for example, a “high tech” community group. The simulation computer can randomly create simulated transactions to associate with the simulant consumer agent based on transactions typically performed by actual consumers of the “high tech” community group. For example, the simulation computer can assign simulated transactions of “new phone—$500,” “groceries—$150,” “car insurance—$75,” etc. to the simulant consumer agent. Each generated simulated transaction may also include any suitable transaction data (e.g., date, time, location, resource provider identifier, consumer identifier, etc.)

At step 314, the simulation computer can assign satisfaction levels and resources to the simulant consumer agents. A satisfaction level can indicate how satisfied a consumer agent is with current resources in an inventory of the consumer agent. The inventory can be a data item which comprises each of the resources that the consumer agent is currently in possession of (e.g., associated with). After generating the simulated transactions for the simulant consumer agent, the simulation computer can assign satisfaction level(s) and resources to the simulant consumer agent based on the simulated transactions. For example, for each simulated transaction, the simulation computer can associate the purchased resource with the simulant consumer agent. For example, the simulation computer can create and store an inventory data item comprising “phone,” “groceries,” and “car insurance” to the above described simulant consumer agent.

The simulation computer can also determine a satisfaction level for the simulant consumer agent. The satisfaction level may be determined by the simulated transactions and the previously determined propensity data of the simulant consumer agent. For example, the simulant consumer agent of the “high tech” community group can be determined to have a high satisfaction level (e.g., 10/10) based on the simulated transaction for the new phone costing $500.

The simulation computer can repeat steps 312 and 314 for each simulant consumer agent of the plurality of simulant consumer agents.

At step 316, the simulation computer can load transaction history data (e.g., the network data associated with the actual consumers) of the actual consumer agents from a database. For example, the simulation computer can load network data comprising transactions associated with the actual consumer associated with the actual consumer agent. The network data can include the transactions associated with the actual consumer.

At step 318, the simulation computer can determine satisfaction levels and resources from the actual consumer transaction history data. For example, the simulation computer can determine resources that the actual consumer purchased in a previous time range (e.g., in the past day, week, month, etc.) based on previous transactions performed by the actual consumer, as indicated in the network data.

As an illustrative example, an actual consumer may be associated (e.g., via a user identifier) with five transactions in the past week. The five transactions can include transactions for food (e.g., from a resource provider that is a grocery store), a cell phone, a bus ticket, books, and coffee. The simulation computer can associate an actual consumer agent (representative of the actual consumer) with resources of 1) food, 2) cell phone, 3) bus ticket, 4) books, and 5) coffee.

The simulation computer can then determine a satisfaction level for the actual consumer agent based on, at least, the resources involved in the transactions. The satisfaction level can represent a value of how content the actual consumer agent is with their current resources. In some embodiments, the satisfaction level can be further based on other data such as community data, propensity data, etc.

For example, the actual consumer agent can be associated with a community of “literature.” The simulation computer can determine that the actual consumer agent has a high satisfaction level since the actual consumer agent is associated with a purchase of “books” in the past week. The high satisfaction level can indicate that the actual consumer agent is satisfied with current resources and may decide not to purchase new resources. As another example, if a second actual consumer agent is associated with a community of “literature,” but has not performed a transaction related to books, or other literature related resources, then the simulation computer can determine a low satisfaction level for the second actual consumer agent. Over subsequent epochs, the satisfaction level may decay using any suitable decay function. For example, the actual consumer agent's satisfaction level may be a value of 10/10 and may decrease by 1 during each epoch during which the actual consumer agent does not purchase “literature” related resources.

The simulation computer can repeat steps 316 and 318 for each of the actual consumer agents. For example, the simulation computer can perform steps 316-318 M times for M actual consumer agents.

At step 320, after creating the simulant consumer agents and the actual consumer agents, the simulation computer can group the simulant consumer agents and the actual consumer agents into K consumer agents. For example, the simulation computer can include into a group (e.g., the K consumer agents) the N simulant consumer agents and the M actual consumer agents. In some embodiments, combining the N simulant consumer agents and the M actual consumer agents can obfuscate the actual consumer agents with the simulant consumer agents. A malicious party may not be able to determine which consumer agents of the K consumer agents correspond to simulant consumer agents and which correspond to actual consumer agents. The use of an adversarial AI, described herein, can further increase the privacy of the actual consumers represented by the actual consumer agents.

At step 322, the simulation computer can determine recommendations for a predetermined amount of epochs for each of the K consumer agents. In some embodiments, the simulation computer can determine the recommendations using a recommendation engine. For example, the simulation computer can project out 10 recommendations for each consumer agent for each epoch. In some embodiments, the simulation computer can determine a recommendation for a consumer agent based on the transaction history, propensity data, and/or community data for the consumer agent.

As an example, the simulation computer can determine recommendations using a collaborative filtering recommendation engine. Collaborative filtering can be based on an assumption that consumers will like similar kinds of items as they have liked in the past. The recommendation engine can generate recommendations using information about rating profiles for different consumer agents or resources. By locating peer consumer agents (e.g., of a similar community group) and/or peer resources (e.g., resources with a category of “electronics”) with a rating history similar to the current consumer agent or resource, the recommendation engine can generate recommendations using these similarities. Collaborative filtering methods can include memory-based and model-based implementations. For example, a memory-based approach can include a consumer agent-based algorithm, whereas an example of a model-based approach can include a Kernel-Mapping Recommender. An advantage of a collaborative filtering approach is that it does not rely on machine analyzable content and therefore is capable of accurately recommending complex items (e.g., resources) without requiring an “understanding” of the item itself. For example, a k-nearest neighbor (k-NN) approach or the Pearson Correlation may be implemented.

For example, if a consumer agent is associated with a transaction history indicating frequent purchases of “books,” then the simulation computer can determine a recommendation of “books” for frequent number of epochs (e.g., recommendations to purchase “books” every 3 epochs). Whereas, if a consumer agent has not purchased “books” in the last year's worth of transactions, then the simulation computer can determine recommendations that do not include “books.”

At step 324, after determining recommendations for each consumer agent for each epoch, the simulation computer can run a first epoch of the simulation. At step 326, the simulation computer can load the data for the first consumer agent of the K consumer agents. The simulation computer may iterate the following steps for each consumer agent.

At step 328, the simulation computer can reweight the recommendations and update the consumer agent's satisfaction level. In some embodiments, during the first epoch the recommendations and satisfaction level may not yet differ from the initial values. However, it is understood that later in the epoch, and in later epochs, the recommendations and satisfaction levels may be updated based on performed simulated transactions and, in some embodiments, when a simulated transaction was not able to be performed. For example, if a consumer agent performs a transaction for a laptop, then the satisfaction level may be increased by an amount which may be proportional to the consumer agent's community group, the consumer agent's propensity data, and/or a predetermined value associated with each resource.

At step 330, after updating the recommendations and the satisfaction level(s), the simulation computer can determine whether or not a first recommendation of the recommendations for the current epoch and the current consumer agent is non-zero (i.e., determine whether or not there is a recommendation). For example, the first consumer agent can be a simulant consumer agent associated with the “high tech” community group can have a recommendation of “laptop.” If the recommendation is non-zero (i.e., there is a recommendation of, for example, “laptop”), then the simulation computer can proceed to step 332. If the recommendation is zero, or null (i.e., there is no recommendation), then the simulation computer can proceed to step 326 to iterate to the next recommendation as well as update the recommendations and satisfaction level(s) as appropriate.

At step 332, the simulation computer can determine the satisfaction level of the consumer agent. In some embodiments, after step 338, the simulation computer can re-determine the satisfaction level of the consumer agent based on a transaction that was not able to be performed. For example, the simulation computer can determine an updated satisfaction level based on the consumer agent's updated inventory comprising new resources if any transactions were performed at step 336.

At step 334, the simulation computer can determine whether or not the consumer agent and/or the resource provider agent are available for a transaction. The simulation computer can determine if the first consumer agent of the K consumer agents is available. In some embodiments, the availability of the consumer agent can be determined based on the consumer agent's budget stored in the constraint data. The first consumer agent can be available if the consumer agent can perform interactions and/or is not presently occupied during the current epoch. Consumer agent availability can depend on the constraint data associated with the consumer agent. For example, the constraint data can include a range of hours that the consumer agent is available to perform purchases (e.g., a schedule). For example, the range of hours can include 5 PM to 9 PM. If the current time of day (of the simulation) is within the range of hours that the consumer agent is available to perform purchases, then the consumer agent can be determined to be available. As another example, the constraint data can include a budget for the consumer agent. If the consumer agent's budget is currently $0, then the simulation computer can determine that the consumer agent is not available to perform transaction(s).

In some embodiments, the availability of a resource provider agent of the plurality of resource provider agents can be based on a consumer capacity value of the resource provider agent. The capacity value can be a number of consumer agents that may transact with the resource provider agent in the current epoch. For example, a resource provider agent that is a “restaurant” may have a consumer capacity value of “120” based on the total number of chairs and/or tables available.

At step 336, if the consumer agent and the resource provider agent are available, then the simulation computer can determine that a transaction can be performed.

In some embodiments, the simulation computer can determine if the consumer agent can achieve a transaction with a first resource provider agent of the plurality of resource provider agents (e.g., I resource provider agents). The determination of whether or not the consumer agent can perform the transaction with the first resource provider agent can be based on the type of resources provided by the first resource provider agent (e.g., the resource basket associated with the first resource provider agent) as well as based on the satisfaction level of the consumer agent.

If the transaction can be performed, then the simulation computer can proceed to step 340. If the consumer agent cannot achieve the transaction, then at step 337, the simulation computer can repeat steps 334-336 for the next resource that the consumer agent may purchase from the resource provider agent. For example, the simulation computer can iterate through 10 resources provided by the resource provider agent. The simulation computer can also iterate through the I resource provider agents. The simulation computer can proceed to step 334 for the next resource provider agent of the I resource provider agents. After step 337, the simulation computer can perform steps 332-336 for each resource provider agent. If step 337 has been performed I times (e.g., one time for each resource provider agent as well as, in some embodiments, for each resource provided by each resource provider agent), then the simulation computer can, at step 338, update the recommendation to zero since the consumer agent could not purchase the recommended resource from any of the resource provider agents. If the simulation computer updates the recommendation to zero, then the simulation computer can break the current loop for the recommendation which was set to zero. In this case, the simulation computer can then proceed to step 326 for the next recommendation for the consumer agent, or if that recommendation was the last recommendation for the consumer agent, then proceed to step 326 for the next consumer agent.

For example, the current recommendation for the consumer agent may be for a laptop and the current resource provider may be a merchant which provides laptops. Based on the resources provided by the resource provider agent (i.e., the resource basket) as well as checking the consumer capacity value, the simulation computer can determine that the transaction for the laptop may be performed.

At step 340, the simulation computer can determine that the consumer agent purchases the resource from the resource provider agent. The simulation computer can store the resource into the inventory associated with the consumer agent. In some embodiments, the simulated transaction can comprise simulated transaction data. The simulated transaction data can include any suitable data associated with the simulated transaction. For example, the simulated transaction data can comprise a simulated user identifier, a simulated resource provider identifier, an amount, an epoch number, and a resource identifier.

As an illustrative example, the simulation computer can add the laptop to the consumer agent's inventory. The simulation computer may also subtract a cost of the laptop from a balance associated with the consumer agent and add the cost of the laptop to a balance associated with the resource provider agent. The cost of the laptop can be randomly selected from a distribution. The distribution may be predetermined and based on network data. As an example, the distribution may be a bell curve centered at an average cost of a resource (e.g., a laptop).

At step 342, the simulation computer can update the satisfaction level of the consumer based on the purchase. For example, the simulation computer can update the satisfaction level by a predetermined amount dependent on the resource and the consumer agent's community group.

For example, the consumer agent belonging to the “high tech” community group may receive an increase in satisfaction level after purchasing the laptop. For example, the simulation computer can increase the satisfaction level from a value of 50 to 100 since the consumer agent purchased a resource associated with the “high tech” community group. As another example, a second consumer agent of a “literature” community group may have a smaller increase in satisfaction level (e.g., 50 to 80) when purchasing a laptop.

The simulation computer can then repeat steps 326-342 for each of the K consumer agents for the current epoch. At step 344, after performing steps 326-342 for each of the K consumer agents, the simulation computer can save the results from the epoch. For example, the simulation computer can store the results into a database. The results can include the performed simulated transactions and, in some embodiments, transaction data associated therewith.

The simulation computer can repeat steps 324-344 for each of the J epochs. At step 344, after running J epochs, the simulation computer can end the process.

### IV. Adversarial AI

In methods according to embodiments of the disclosure, two adversarial AI's can tune the simulation and make sure that the simulation cannot be used to identify an individual.

An adversarial AI can include an artificial intelligence which can attempt to fool models through malicious input. In some embodiments, systems as described herein can include a model tuning adversarial AI and/or a privacy protection adversarial AI.

A. Adversarial AI: Model Tuning

The simulation computer can comprise a first adversarial AI that can compare generated data with true data (e.g., the network data). The first adversarial AI can provide learner error matrixes to tune the model. The simulation computer can determine the error between generated data and the network data using the first adversarial AI.

The simulation computer can tune the model using an adversarial deep learning AI. The AI can be given real world data (e.g., measured data) and simulated data at various summary levels. The data can be split into two samples, a training set and a validation set. The simulation computer can first build the model using the training set and can then then evaluate the model using the validation set. The residual, from the evaluation, can be used to reweight data based on error in a similar fashion to boosting. For example, if the model ran with only resource providers being simulated, the error matrix would be matched to consumers, changing their weights accordingly.

For example, in some embodiments, the simulation computer can compare the plurality of actual consumer agents and the plurality of simulant consumer agents. The simulation computer can then remove, based on the comparing, actual consumer agents from the plurality of actual consumer agents which do not exceed a matching threshold when compared to the plurality of simulant consumer agents.

FIG. 4 shows a method of model tuning according to an embodiment of the disclosure. At step 402, the adversarial AI can determine an initial error matrix. The initial error matrix can be a matrix of zeros. In some embodiments, after executing the adversary AI at steps 416-424, the simulation computer can update the error matrix using residuals of the actual consumer agents. An error can be the difference between an observed value and a true value (very often unobserved). A residual can be the difference between an observed value and a predicted value.

At step 404, after creating the initial error matrix, the simulation computer can retrieve an ensemble sample of data from a weighted multilayered network incidence matrix, at step 406, which may be a representation of the network data. The ensemble sample can be a sample of data which is representative of the network data as a whole. For example, the ensemble sample can comprise transaction data for a plurality of actual consumers, where the plurality of actual consumers are of a similar distribution as all of the actual consumers of the network data. The distribution may be of any suitable data (e.g., income distribution, community group distribution, location distribution, etc.).

At step 408, the simulation computer can determine consumer agents based on the plurality of actual users of the ensemble sample. The simulation computer can determine the consumer agents as described herein.

At step 410, the simulation computer can then determine community groups for the consumer agents. In some embodiments, the simulation computer can determine community groups for the consumer agents based on prior data, at step 412, stored from performing previous simulations. For example, the prior data can include community groups from previous simulations. At step 414, the simulation computer can then perform a simulation, as described herein, for N epochs.

At step 416, the simulation computer can utilize the adversary AI to determine whether or not a give consumer agent is an actual consumer agent or a simulant consumer agent. The determinations of which kind of consumer agent a particular consumer agent belongs to can then be used to update the actual consumer agents determined during steps 404-408 as well as update the simulant consumer agents.

The simulation computer can implement the adversary AI during steps 416-424. At step 418, the simulation computer can determine whether a consumer agent is a simulant consumer agent or an actual consumer agent. For example, the simulation computer can use a support vector machine (SVM) trained to classify a consumer agent as either a simulant consumer agent or an actual consumer agent.

At step 420, after determining whether the consumer agent is a simulant consumer agent or an actual consumer agent, the simulation computer can score the simulant consumer agents and the actual consumer agents. The score can include any suitable score determined by, for example, the support vector machine which determined the type of consumer agent. In some embodiments, the score can include a distance from the consumer agent to a hyperplane used to make decisions regarding the consumer agents.

In some embodiments, the simulation computer can determine residuals of the difference between the consumer agent and the determination of the consumer agent type by the adversarial AI. The difference can be, for example, a distance in vector space. When reweighting the data, the residuals can be transformed/adjusted (e.g., by determining a log of the square of the residuals) to minimize the effect of any one epoch on the consumer agents as a whole.

In other embodiments, the actual consumer agents can be scored based on how well the simulated behavior aligns with actual behavior. To do this the simulation computer may examine predicted outcomes (e.g., predicted simulated transactions) and compared that with actual data to see if a similar event occurred. If a similar event occurred, the simulation computer may examine a time difference and spend difference (e.g., simulated predicted 10 dollars one week from now but the simulation recorded 15 dollars one month from now). If the event was not seen, then the simulation computer can use 0 dollars and 12 months as the actual for calculating residuals. If there was an actual event the model missed, the simulation computer can use 0 dollars and 12 months for the simulated event when calculating the residuals. The residuals may be squared then summed. The simulant consumer agents are scored similarly to the actual consumer agents but at an aggregate level, most often at the graph community level.

At step 422, the simulation computer can then update the actual consumer agents. For example, a first consumer agent may be an actual consumer agent, but may have been determined to be a simulant consumer agent by the adversarial AI. The actual consumer agent may be associated with limited network data (e.g., a few transactions) in the past year, thus leading the adversarial AI to determine the actual consumer agent as a (poorly created) simulant consumer agent. For example, the first actual consumer may perform two transactions per month using a first credit card. A first actual consumer agent generated from the first actual consumer may have very limited behavior due to the lack of transaction history. When the adversarial AI examines the first actual consumer agent, due to the limited transaction history, the adversarial AI can determine the first actual consumer agent resembles a simulant consumer agent. Then, when the simulation computer updates the actual consumer agents, at step 422, the simulation computer can remove the first actual consumer from the ensemble sample and retrieve network data for a new actual consumer to include in the ensemble sample.

At step 424, the simulation computer can update the simulant consumer agents. For example, the simulation computer can update distributions and/or ranges for values which may be randomly sampled to create values for the simulant consumer agent. For example, the simulation computer can edit a range of incomes that can be randomly selected when generating simulant consumer agents, based on whether or not the adversarial AI determines a particular simulant consumer agent to be an actual consumer agent (i.e., meaning that the simulant consumer agent accurately represents an actual consumer agent).

B. Adversarial AI: Privacy Protection

In some embodiments, the simulation computer can also comprise a second adversarial AI that can determine whether or not the simulated data can be used to identify an individual using various non-transaction data elements. If the second adversarial AI can identify an individual, then the privacy of the individual has not been preserved in the model. In this case, the simulation computer can perform agent determination again for the relevant agent.

Several simulation are run out n epochs with consumer agents at a 1 to 1 match. The data can be split between the training set and the validation set. True transactional data can be pulled from an analogous actual time frame within the data. The adversarial AI can build a model using the training set and can then evaluate the model using the validation set. The model attempts to predict where a given consumer will be at a set time.

In some embodiments, noise can be introduced to the network data to help obfuscate selected consumers whose actions are predicted too actually based on a predefined threshold. The noise can be in the form of data removal, swapping information between consumers, fuzzifing key elements of a transaction (e.g., amount) or shift a timeline.

Embodiments of the disclosure provide for a number of advantages. For example, embodiments provide for a simulation that may comprise both actual consumer agents and simulant consumer agents, which can be beneficial by obfuscating the actual consumer agents with the simulant consumer agents from a malicious party.

Embodiments of the disclosure provide for a number of additional advantages. For example, if limited data (e.g., network data) is available, the simulation computer may still be able to perform simulations comprising enough consumer agents to preserve prediction precision using generated consumer agents. For example, if network data is limited to 100 actual consumers corresponding to 100 actual consumer agents, the simulation computer can create 100, or other suitable number, simulant consumer agents to be incorporated in the simulation. The simulation may not be limited by a lack of network data.

It should be understood that any of the embodiments of the present disclosure can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

As used herein, the use of “a,” “an,” or “the” is intended to mean “at least one,” unless specifically indicated to the contrary.

What is claimed is:

1. A method comprising:
a) receiving, by a computer, network data comprising a plurality of transactions conducted by a plurality of actual users and a plurality of actual resource providers;
b) generating, by the computer, a plurality of simulated users, each simulated user based upon a set of the plurality of actual users;
c) generating, by the computer, a plurality of simulated resource providers, each simulated resource provider based upon at least one actual resource provider;
d) executing, by the computer, a simulation using the plurality of simulated users and the plurality of simulated resource providers; and
e) determining, in response to step d), a plurality of simulated transactions conducted by the plurality of simulated users and the plurality of simulated resource providers.

2. The method of claim 1, wherein d) executing, by the computer, the simulation using the plurality of simulated users and simulated resource providers, comprises d) executing, by the computer, a simulation using the plurality of simulated users and the plurality of simulated resource providers, and transaction data for transactions conducted by the actual users associated with the simulated users.

3. The method of claim 2, wherein the plurality of simulated users are a plurality of simulant consumer agents, and wherein generating the plurality of simulant consumer agents further comprises:
generating, by the computer, random simulated transactions for a transaction history associated with each simulant consumer agent of the plurality of simulant consumer agents, wherein the random simulated transactions are based on the set of the plurality of actual users.

4. The method of claim 3 further comprising:
generating, by the computer, a plurality of actual consumer agents based upon a plurality of actual users, respectively.

5. The method of claim 4, wherein d) executing, by the computer, the simulation using the plurality of simulated users and simulated resource providers, comprises d) executing, by the computer, the simulation using the plurality of simulant consumer agents, the plurality of actual consumer agents, and the plurality of simulated resource providers, and the transaction data for the transactions conducted by the actual users associated with the plurality of actual consumer agents.

6. The method of claim 4 further comprising:
comparing, by the computer, the plurality of actual consumer agents and the plurality of simulant consumer agents; and
removing based on the comparing, by the computer, actual consumer agents from the plurality of actual consumer agents which do not exceed a matching threshold when compared to the plurality of simulant consumer agents.

7. The method of claim 1, wherein each simulated user of the plurality of simulated users comprises at least community data, constraint data, and propensity data.

8. The method of claim 1, wherein the simulation comprises a plurality of epochs, and wherein d) executing, by the computer, a simulation further comprises:
determining, by the computer, a plurality of recommendations for each epoch of the simulation for each simulated user of the plurality of simulated users; and
determining, by the computer, whether or not each simulated user performs a simulated transaction based on the plurality of recommendations for each epoch.

9. The method of claim 8 further comprising:
updating, by the computer, the recommendations of the plurality of recommendations if the simulated user performs the simulated transaction; and
storing, by the computer, the simulated transaction into a list of simulated transactions.

10. The method of claim 9, wherein the simulated transaction comprises simulated transaction data comprising a simulated user identifier, a simulated resource provider identifier, an amount, an epoch number, and a resource identifier.

11. A computer comprising:
a processor; and
a computer-readable medium coupled to the processor, the computer-readable medium comprising code executable by the processor for implementing a method comprising:
a) receiving network data comprising a plurality of transactions conducted by a plurality of actual users and a plurality of actual resource providers;
b) generating a plurality of simulated users, each simulated user based upon a set of the plurality of actual users;
c) generating a plurality of simulated resource providers, each simulated resource provider based upon at least one actual resource provider;
d) executing a simulation using the plurality of simulated users and simulated resource providers; and
e) determining, in response to step d), a plurality of simulated transactions conducted by the plurality of simulated users and the plurality of simulated resource providers.

12. The computer of claim 11, wherein d) executing the simulation using the plurality of simulated users and simulated resource providers, comprises d) executing a simulation using the plurality of simulated users and the plurality of simulated resource providers, and transaction data for transactions conducted by the actual users associated with the simulated users.

13. The computer of claim 12, wherein the plurality of simulated users are a plurality of simulant consumer agents, and wherein generating the plurality of simulant consumer agents further comprises:
generating random simulated transactions for a transaction history associated with each simulant consumer agent of the plurality of simulant consumer agents, wherein the random simulated transactions are based on the set of the plurality of actual users.

14. The computer of claim 13, wherein the method further comprises:
generating a plurality of actual consumer agents based upon a plurality of actual users, respectively.

15. The computer of claim 14, wherein d) executing the simulation using the plurality of simulated users and simulated resource providers, comprises d) executing the simulation using the plurality of simulant consumer agents, the plurality of actual consumer agents, and the plurality of simulated resource providers, and the transaction data for the transactions conducted by the actual users associated with the plurality of actual consumer agents.

16. The computer of claim 15, wherein the network data is received from a network data database, and wherein a network processing computer stores the transaction data for the transactions conducted by the plurality of actual users and the plurality of actual resource providers into the network data database.

17. The computer of claim 11, wherein each simulated user of the plurality of simulated users comprises at least community data, constraint data, and propensity data.

18. The computer of claim 11, wherein the simulation comprises a plurality of epochs, and wherein d) executing a simulation further comprises:
determining a plurality of recommendations for each epoch of the simulation for each simulated user of the plurality of simulated users; and
determining whether or not each simulated user performs a simulated transaction based on the plurality of recommendations for each epoch.

19. The computer of claim 18, wherein the method further comprises:
updating the recommendations of the plurality of recommendations if the simulated user performs the simulated transaction; and
storing the simulated transaction into a list of simulated transactions.

20. The computer of claim 11, wherein the computer is a simulation computer, and wherein the computer readable medium comprises:
an agent creation module;
a simulation module; and
an adversarial AI module.
